(19) United States
(12) Patent Application Publication
(10) Pub. No.: US 2006/0220540 A1
(43) Pub. Date: Oct. 5, 2006

(54) Organic electroluminescent display panel

(75) Inventors: Chung-Chun Lee, Lunbei Township (TW); Shi-Hao Li, Banciao City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/256,432

(22) Filed: Oct. 21, 2005

(30) Foreign Application Priority Data
Mar. 31, 2005 (TW) 94110255

(51) Int. Cl. H05B 33/00

(52) U.S. Cl. 313/506; 313/503; 313/504

(57) ABSTRACT

An organic electroluminescent display (OLED) panel comprises a reflective layer, an organic layer disposed overlying the reflective layer, and at least one transparent material layer of no less than 500 nm in thickness disposed on the reflective layer and adjacent to the organic material layer.

### BACKGROUND

The invention relates to a display panel, and more particularly to an organic electroluminescent display panel.

Organic materials have been widely applied in various circuit devices. An organic electroluminescent display panel (OLED) made from organic materials has the advantages of simple structure, excellent working temperature, contrast and viewing angle with light-emitting diode (LED) communication and luminescent characteristics.

Most OLED panels emit light from a bottom substrate, this is referred to as bottom emission. Conversely, top emission panels emit from the top of the substrate. Top-emitting elements are also referred to as surface-emitting OLED panels.

Active organic electroluminescent elements are controlled by thin film transistors (TFT). If light emits via bottom emission, the light through a substrate must be stopped by TFT and metallic circuits on the substrate so that actual emitting area is limited and reduced, i.e. the aperture ratio is reduced. If the number of TFTs increases, the aperture ratio is further reduced. However, if top emitting elements are used, light emits from the top rather than passing through a substrate. Therefore, the light is not stopped by TFTs and metallic circuits. Thus, a panel with high resolution, good illumination and elongated lifetime is easily produced without concerning the number of TFTs.

However, top-emitting OLED panels are known to have some drawbacks. For example, they have severe optical interference caused by half- or full-reflecting electrodes and short optical pathways. This causes brightness decay during viewing angle changes and causes emissive color changes, color of light and sensitivity to thickness of elements.

To overcome these problems, research has been devoted to lowering the reflectance of electrodes so as to increase the transmission rate. However, most research has been limited to OLED processing and the achieved effects were quite limited. Some research did not consider lowering optical interference but used optical interference to increase the efficiency and solve color deviation occurring in viewing-angle changes by color filters. Nevertheless, brightness decay during viewing-angle changes and color of light and efficiency sensitive to thickness of elements still exist due to interference.

Therefore, a new organic electroluminescent display panel to solve optical interference is desirable.

### SUMMARY

The invention provides an organic electroluminescent display panel comprising a reflective layer, an organic material layer disposed overlying the reflective layer, and at least one transparent material layer of no less than 500 nm in thickness disposed on the reflective layer and adjacent to the organic material layer.

In another aspect, the invention provides an organic electroluminescent display panel comprising a reflective electrode layer having a reflective surface, an organic material layer disposed on the reflective surface, and a transparent electrode layer disposed on the organic material layer.

The transparent electrode layer has an emitting surface located on the side away from the organic material layer, and the distance between the reflective surface and the emitting surface is no less than 600 nm, preferably more than 650 nm, more preferably more than 700 nm.

In another aspect, the invention provides an organic electroluminescent display panel comprising a reflective layer having a reflective surface, a first transparent electrode layer disposed on the reflective surface, an organic material layer disposed on the first transparent electrode layer, and a second transparent electrode layer disposed on the organic material layer.

The second transparent electrode layer has an emitting surface located on the side away from the organic material layer, and the distance between the reflective surface and the emitting surface is no less than 600 nm, preferably more than 650 nm, more preferably more than 700 nm.

### DESCRIPTION OF THE DRAWINGS

The present invention will be more fully understood and further advantages will become apparent when reference is made to the following description of the invention and accompanying drawings in which:

FIG. 1 illustrates a schematic cross sectional view of an embodiment of an organic electroluminescent display panel of the invention.

FIG. 2 illustrates a schematic cross sectional view of another embodiment of an organic electroluminescent display panel of the invention.

FIG. 3 illustrates a schematic cross sectional view of another embodiment of an organic electroluminescent display panel of the invention.

FIG. 4 illustrates relationship between total thickness and emissive color of the display elements in a top-emitting organic electroluminescent display panel.

It is to be understood that the thickness of every element is not actual scale.

### DETAILED DESCRIPTION

One object of the invention is to provide a top-emitting organic electroluminescent display panel in order to reduce the optical interference phenomenon.

The organic electroluminescent display panel of the invention comprises a reflected layer, an organic material layer disposed overlying the reflective layer, and at least one transparent material layer of no less than 500 nm in thickness disposed on the reflective layer and adjacent to the organic material layer. The thickness of the transparent material layer depends on actually designed organic electroluminescent display panel structure. The transparent material layer is usually thicker than or equal to 500 nm. For use in thinner organic material layer or easily controlling production condition etc., the thickness of the transparent material layer can be adequately increased. For example, it can be increased up to 520 nm, 550 nm, 600 nm, or 650 nm in thickness. In one embodiment, described in the following, however, when the reflective layer, corresponding to the organic material layer, is disposed on the other side of the bottom substrate, the thickness of the transparent material layer can be relatively reduced because the thickness of the bottom substrate also increases the optical pathway.

According to one embodiment of the invention, a top-emitting electroluminescent display panel comprises a bottom substrate and an organic material layer disposed on the bottom substrate. The organic material layer comprises a lower electrode, an organic light-emitting layer and an upper electrode. The lower electrode comprises a reflective electrode. The upper electrode disposed on the organic light-emitting layer is a transparent electrode and is no less than 500 nm in thickness. Light emitted from the organic light-emitting layer partially travels upward, and partially travels downward and is reflected upward by the lower electrode to provide the display function.

According to another embodiment of the invention, a top-emitting electroluminescent display panel comprises a bottom substrate and an organic material layer disposed on the bottom substrate. The organic material layer comprises a lower electrode disposed on the bottom substrate. The lower electrode comprises a first lower electrode and a second electrode disposed on the first lower electrode, wherein the first lower electrode is a reflective electrode, and the second electrode is a transparent electrode and is no less than 500 nm in thickness. The organic material layer further comprises an organic light-emitting layer disposed on the lower electrode for emission, and an upper electrode disposed on the organic light-emitting layer is a transparent electrode. Light emitted from the organic light-emitting layer partially travels upward, and partially travels downward passing through the second lower electrode and is reflected upward by the first electrode to provide the display function.

According to another embodiment of the invention, a top-emitting organic electroluminescent display panel comprises a reflective film, a thick optical transmitting film of no less than 500 nm in thickness disposed on the reflective film and an organic material layer for emission disposed on the thick optical transmitting film. The organic material layer comprises a lower electrode, an organic light-emitting layer and an upper electrode. The lower electrode comprises a transparent electrode. The upper electrode disposed on the organic luminescent layer is a transparent electrode. Light emitted from the organic material layer partially travels upward, and partially travels downward through the thick optical transmitting film and is reflected upward by the reflective film to provide the display function.

Other characteristics and advantages of the invention will become apparent in the continuation of the description with the examples represented below. The examples in conjunction with the figures describe the invention in detail.

### EXAMPLES

The organic electroluminescent display panel of the invention comprises: a reflective layer; an organic material layer disposed overlying the reflective layer; and at least one transparent material layer of no less than 500 nm in thickness disposed on the reflective layer and adjacent to the organic material layer. The organic material layer is used for emitting upward and downward separately. The upward emission directly transmits the transparent material layer, and the downward emission is reflected upward by the reflective layer and passes through the transparent material layer, then combines with the upward emission to provide the display function.

The thick transparent material layer is disposed on the reflective layer. Except that the position of the transparent material layer is adjusted depending on the demanding of products, the transparent material layer can be optionally designed and further combined with other appropriate display elements. For example, a thick transparent material layer is disposed on upper electrodes, lower electrodes, or any layer in the display panel except for the organic emitting elements. Thus, an increase in thickness due to the thick transparent material layer does not influence operating voltage of elements, but elongates optical pathway so as to largely reduce interference in organic electroluminescent display panels. For further illustrating the invention, examples recited below explain various modifications of the invention. The figures recited below are sketches. It will be understood that the thickness of every element is not actual scale.

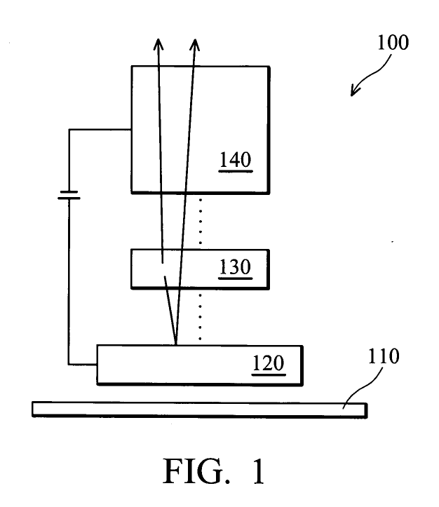

In FIG. 1, the organic electroluminescent display panel 100 comprises a bottom substrate 110, a reflective layer 120 disposed on the bottom substrate 110, an organic material layer 130 disposed on the reflective layer 120, and at least a transparent material layer 140 of no less than 500 nm thickness disposed on the reflective layer 120 and adjacent to the organic material layer 130. The organic material layer 130 emits upward and downward separately. The upward emission directly transmits the transparent material layer 140, and the downward emission is reflected upward by the reflective layer 120, passes through the transparent material layer 140 and combines with the upward emission to provide the display function.

In one embodiment of the invention, the reflective layer 120 is a reflective electrode comprising, for instance, Al, Ca, Ag, Ni, Cr, Ti, Mg—Ag alloy, and Mg, or combination thereof, or a single-layer or multilayer structure consisting of the combination of the materials listed above and ITO, IZO, ZnO, InN or SnO₂. The organic material layer 130 comprises an electron transport layer, an organic light-emitting layer and a hole transport layer. Alternatively, the organic material layer further comprises an electron injection layer disposed between the hole transport layer and cathodes, or a hole injection layer disposed between the hole transport layer and anodes for emitting upward and downward simultaneously. The transparent material layer 140 disposed on the organic material layer 130 is a transparent electrode comprising ITO, IZO, ZnO, InN, SnO₂, or combination thereof, or a single-layer or multilayer structure consisting of the combination of the materials listed above and trace metal blends, such as Ni, Ag or Cu.

In one embodiment of the invention, the organic electroluminescent display panel 100 further comprises a transparent electrode (not shown) disposed between the organic material layer 130 and reflective layer 120, which further increases total thickness of the elements in the organic electroluminescent display panel 100.

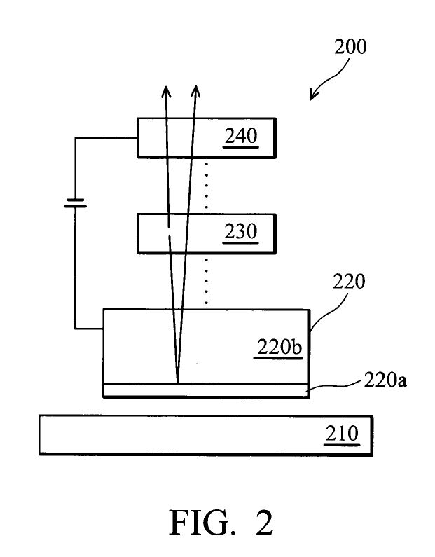

In FIG. 2, an organic electroluminescent display panel 200 comprises a bottom substrate 210, a lower electrode 220 disposed on the bottom substrate 210, an organic material layer 230 disposed on the lower electrode 220, and an upper electrode 240 disposed on the organic material layer 230. It is noted that lower electrode 220 comprises a first lower electrode 220a and a second lower electrode 220b disposed on the first lower electrode 220a. The first lower electrode 220a is a reflective electrode, and the second lower electrode 220b is a transparent electrode of no less than 500 nm in thickness, while the upper electrode 240 is a transparent electrode. Accordingly, light emitted by the organic material layer 230 travels upward through the upper electrode 240, and also travels downward passing through the second lower electrode 220b. The light is then reflected upward due to the first lower electrodes 220a and passes through the second lower electrode 220b, the organic material layer 230 and the upper electrode 240 and combines with the upper emission to provide the display function.

In this embodiment, the first electrode 220a is a reflective electrode comprising, for instance, Al, Ca, Ag, Ni, Cr, Ti, Mg—Ag alloy, and Mg, or combination thereof, or a single-layer or multiple-layer structure consisting of the combination of the materials listed above and ITO, IZO, ZnO, InN or SnO₂. The second lower electrode 220b and the upper electrode 240 are both transparent electrodes, comprising ITO, IZO, ZnO, InN, SnO₂, or combination thereof, or a single-layer or multiple-layer structure consisting of the combination of the materials listed above and trace metal blends, such as Ni, Ag or Cu. As the organic material layer 130 described above, the organic material layer 230 comprises an electron transport layer, an organic light-emitting layer and a hole transport layer. Alternatively, the organic material layer 230 further comprises an electron injection layer between the hole transport layer and cathodes, or a hole injection layer is disposed between the hole transport layer and anodes for emitting upward and downward simultaneously.

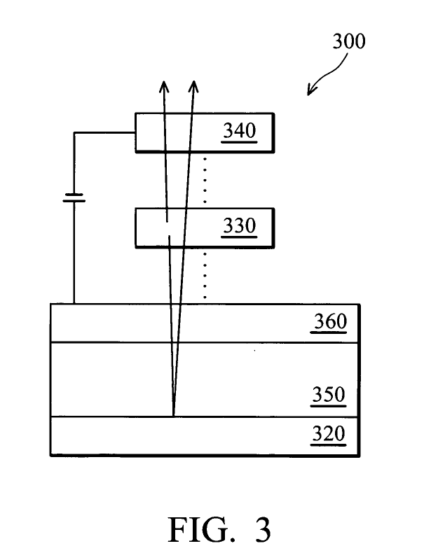

In FIG. 3, an organic electroluminescent display panel 300 comprises a reflective layer 320, a transparent material layer 350 of no less than 500 nm in thickness disposed on the reflective layer 320, a lower electrode 360 disposed on the transparent material layer 350, an organic material layer 330 disposed on the lower electrode 360 and an upper electrode 340 disposed on the organic material layer 330. The upper electrode 340 and the lower electrode 360 are both transparent electrodes. Accordingly, light emitted from the organic material layer 330 travels upward through the upper electrode 340 and also travels downward passing through the lower electrode 360 and the transparent material layer 350. The light is then reflected upward by the reflective layer 320 and passes through the transparent material layer 350, the lower electrode 360, the organic material layer 330 and the upper electrode 340, and combines with the upper emission to provide the display function.

In this embodiment, the same as the organic material layer 130 or 230 described above, the organic material layer 330 comprises an electron transport layer, an organic light-emitting layer and a hole transport layer. Alternatively, the organic material layer 330 further comprises an electron injection layer between the hole transport layer and cathodes, or a hole injection layer is disposed between the hole transport layer and anodes. The upper electrode 340 and the lower electrode 360 are both transparent electrodes and have the same materials as the transparent electrodes described above. The transparent material layer 350 can be positioned on a protection layer or an isolation layer disposed on the bottom substrate (not shown), comprising a SiOₓ layer, a SiNₓ layer, an organic material or a single-layer or multiple-layer structure consisting of the combination thereof. The reflective layer 320 can be disposed on the bottom substrate (not shown), for example, a driving circuit of the bottom substrate (not shown). Alternatively, the reflective layer 320 can also be disposed under the bottom substrate (not shown) and use a transparent bottom substrate, such as a glass substrate, to be a transparent material layer 350.

The operating theory of the organic electroluminescent display panel of the invention is further illustrated in the following.

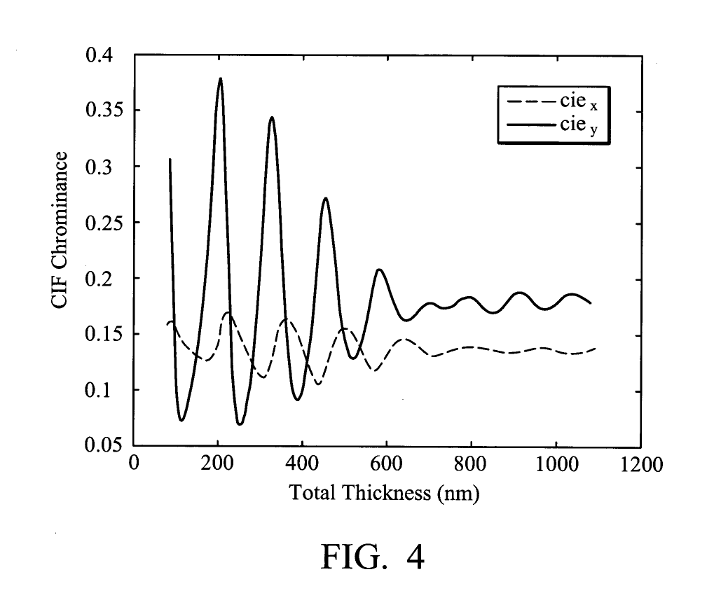

One of ordinary skill in the art will understand that light beams pass through films depending on the optical pathway or the influence of the optical film according to interference theory. Top-emitting organic electroluminescent display panels cause the optical interference to be obvious because some light beams, during emission, are reflected by substrates with high reflective rate. In FIG. 4, it is noted that fluctuation of chrominance is largely reduced when total thickness of the display panel increases up to a specific level (such as 600-700 nm) due to a large increase of optical pathway. The invention is based on the theory that optical interference effects can be eliminated by adding a thick transparent material layer to increase total thickness of the display panel. In the examples described above, the total thickness of the invention is the distance from the reflective surface of the reflective layer or reflective electrode layer to the emitting surface of the display panel, which is no less than 600 nm, preferably more than 650 nm, more preferably more than 700 nm.

In comparison with the related art, the invention increases the optical pathway by adding a thick transparent material layer in order to inhibit optical interference effect. The invention not only improves display quality but also increase display panel brightness by selection of higher reflection rate materials as electrodes to increase quantum efficiency of elements without the limitation of optical interference.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An organic electroluminescent display panel, comprising:
a reflective layer;
an organic material layer disposed overlying the reflective layer; and
at least one transparent material layer of no less than 500 nm in thickness disposed on the reflective layer and adjacent to the organic material layer.

2. The organic electroluminescent display panel as claimed in claim 1, wherein the reflective layer is comprised of an electrode.

3. The organic electroluminescent display panel as claimed in claim 2, wherein the transparent material layer is disposed on the organic material layer.

4. The organic electroluminescent display panel as claimed in claim 3, wherein the transparent material layer is comprised of an electrode.

5. The organic electroluminescent display panel as claimed in claim 2, wherein the organic material layer comprises an electron transport layer, an organic light-emitting layer, and a hole transport layer.

6. The organic electroluminescent display panel as claimed in claim 2, wherein the organic material layer comprises an electron injection layer, an electron transport layer, an organic light-emitting layer, a hole transport layer, and a hole injection layer.

7. The organic electroluminescent display panel as claimed in claim 2, further comprising a transparent electrode disposed between the reflective layer and the organic material layer.

8. The organic electroluminescent display panel as claimed in claim 2, wherein the transparent material layer is disposed between the reflective layer and the organic material layer.

9. The organic electroluminescent display panel as claimed in claim 8, wherein the transparent material layer is comprised of an electrode.

10. The organic electroluminescent display panel as claimed in claim 8, further comprising an electrode disposed on the organic material layer.

11. The organic electroluminescent display panel as claimed in claim 1, wherein the transparent material layer is disposed between the reflective layer and the organic material layer.

12. The organic electroluminescent display panel as claimed in claim 11, further comprising a transparent electrode disposed between the transparent material layer and the organic material layer.

13. The organic electroluminescent display panel as claimed in claim 11, further comprising an electrode disposed on the organic material layer.

14. The organic electroluminescent display panel as claimed in claim 1, further comprising a transparent substrate disposed between the reflective layer and the transparent material layer.

15. The organic electroluminescent display panel as claimed in claim 1, wherein the thickness of the transparent material layer is more than about 550 nm.

16. An organic electroluminescent display panel, comprising:
a reflective electrode layer having a reflective surface;
an organic material layer disposed on the reflective surface; and
a transparent electrode layer, disposed on the organic material layer, having an emitting surface located on the side away from the organic material layer,
wherein the reflective surface is separated from the emitting surface by a distance of no less than about 600 nm.

17. The organic electroluminescent display panel as claimed in claim 16, wherein the distance is more than about 650 nm.

18. The organic electroluminescent display panel as claimed in claim 16, wherein the distance is more than about 700 nm.

19. An organic electroluminescent display panel, comprising:
a reflective layer having a reflective surface;
a first transparent electrode layer disposed on the reflective surface;
an organic material layer disposed on the first transparent electrode layer; and
a second transparent electrode layer, disposed on the organic material layer, having an emitting surface located on the side away from the organic material layer,
wherein the reflective surface is separated from the emitting surface by a distance of no less than about 600 nm.

20. The organic electroluminescent display panel as claimed in claim 19, wherein the distance is more than about 650 nm.

21. The organic electroluminescent display panel as claimed in claim 19, wherein the distance is more than about 700 nm.

22. The organic electroluminescent display panel as claimed in claim 19, further comprising a substrate disposed under the reflective layer.

23. The organic electroluminescent display panel as claimed in claim 19, further comprising a substrate disposed between the reflective layer and the first transparent material layer.

24. The organic electroluminescent display panel as claimed in claim 23, wherein the distance is more than about 650 nm.

25. The organic electroluminescent display panel as claimed in claim 23, wherein the distance is more than about 700 nm.
